(19) United States
(12) Patent Application Publication
(10) Pub. No.: US 2010/0211354 A1
(43) Pub. Date: Aug. 19, 2010

(54) APPARATUS FOR ACQUIRING 3-DIMENSIONAL GEOMATICAL INFORMATION OF UNDERGROUND PIPES AND NONCONTACT ODOMETER USING OPTICAL FLOW SENSOR AND USING THE SAME

(76) Inventors: Hyuk-sung Park, Seoul (KR); Kyung-Soo Min, Gyeonggi-Do (KR); Sang-Bong Park, Gyeonggi-Do (KR); Dong-Hyun Kim, Busan (KR); Mun-Suk Cheon, Seoul (KR); Jum-Soo Sun, Seoul (KR); Hyun-Seok Yang, Seoul (KR); Dong-Jun Hyun, Seoul (KR); Jing-Sung Kim, Seoul (KR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/669,546

(22) PCT Filed: Jul. 18, 2008
(86) PCT No.: PCT/KR08/04206

§ 371 Date: Apr. 27, 2010

(30) Foreign Application Priority Data
Jul. 19, 2007 (KR) 10-2007-0072043
Jan. 17, 2008 (KR) 10-2008-0005163

(51) Int. Cl. G01B 11/14; G01V 3/08

(52) U.S. Cl. 702/165; 356/4.01

(57) ABSTRACT

An apparatus to acquire 3-dimensional geographical information of an underground pipe includes an in-pipe transfer unit which moves along the inside of the underground pipe, a sensing unit which senses 3-dimensional location information of the in-pipe transfer unit, and an information storage unit which stores a value measured by the sensing unit. Accordingly, the depth at which the underground pipe is located as well as 2-dimensional location information of the underground pipe is stored in the information storage unit so that maintenance and repair of the underground pipe can be carried out with greater efficiency.

### TECHNICAL FIELD

The present invention relates to an apparatus for acquiring three-dimensional geographical information on an underground pipe and a non-contact moving distance measurement unit mountable on the apparatus.

### BACKGROUND ART

Inventions related to apparatuses for inspecting underground pipes include the following:

1) U.S. Pat. No. 6,243,657 issued on Jun. 5, 2001 “Method and apparatus for determining location of characteristics of a pipeline”

2) U.S. Pat. No. 5,417,112 issued on May 23, 1995 “Apparatus for indicating the passage of a pig moving within an underground pipeline”

3) U.S. Pat. No. 4,714,888 issued on Dec. 22, 1987 “Apparatus for observing the passage of a pig in a pipeline”

4) U.S. Pat. No. 6,857,329 issued on Feb. 22, 2005 “Pig for detecting an obstruction in a pipeline”

5) US Patent 2003/0,121,338 published on Jul. 3, 2003 “Pipeline pigging device for the non-destructive inspection of the fluid environment in a pipeline”

Apparatuses for inspecting an underground pipe can generally acquire two-dimensional geographical information, hit cannot acquire data regarding the depth of the pipe. Therefore, general apparatuses for inspecting underground pipes have the limitation that it is difficult to efficiently maintain and preserve the pipe. The approximate location of the pipe is marked on a map, but the depth at which the pipe is buried is not marked, which may cause an excavation worker to damage the pipe by mistake. Accordingly, an apparatus is required to collect not only two-dimensional location, but also the depth of the underground pipe in a database.

### DISCLOSURE OF INVENTION

### Technical Problem

To resolve the above problems, the present invention provides an apparatus for acquiring three-dimensional geographical information instead of two-dimensional location information on an underground pipe so that information regarding the depth of the underground pipe may be collected in a database.

To resolve above problems, the present invention also provides an apparatus for acquiring three-dimensional geographical information on an underground pipe while not cutting off water flowing in the underground pipe.

### Technical Solution

According to an exemplary aspect of the present invention, there is provided an apparatus for acquiring three-dimensional geographical information on an underground pipe, the apparatus including an in-pipe transferring device to move in an underground pipe; a detection means to detect three-dimensional geographical information on the in-pipe transferring device; and an information storage means to store values measured by the detection means.

The detection means may include a moving direction measurement unit to measure a direction in which the in-pipe transferring device moves; a moving speed measurement unit to measure a speed at which the in-pipe transferring device moves; and a moving distance measurement unit to measure a distance in which the in-pipe transferring device moves.

The moving distance measurement unit may be an odometer, and may include a laser unit to emit a parallel laser beam having predetermined illumination areas; a sensor unit disposed to be perpendicular to an optical axis of the laser beam emitted by the laser unit; and a beam splitter disposed on optical axes of the laser unit and the sensor unit, to reflect the laser beam emitted by the laser unit on a ground, and to penetrate the laser beam reflected by the ground to the sensor unit.

The in-pipe transferring device may be formed as a floating body with a diameter smaller than that of the underground pipe so as to float on the fluid flowing in the underground pipe, and having the same specific gravity as the fluid flowing in the underground pipe.

The in-pipe transferring device may be formed as a pig body or a running robot.

The detection means may further include a camera device to acquire inner vision data of the underground pipe or a communication module disposed at predetermined locations in the underground pipe; and a wireless communication apparatus to acquire geographical information by communicating with the communication module.

According to another exemplary aspect of the present invention, there is provided a non-contact odometer, including a laser unit to emit a parallel laser beam having predetermined illumination areas; a sensor unit disposed to be perpendicular to an optical axis of the laser beam emitted by the laser unit; and a beam splitter disposed on optical axes of the laser unit and the sensor unit, to reflect the laser beam emitted by the laser unit on a ground, and to penetrate the laser beam reflected by the ground to the sensor unit.

The sensor unit may include an optical flow sensor comprising a light receiving surface which detects the laser beam; and a digital signal processing system to process a photoelectrical signal output from the optical flow sensor to a digital signal, and to calculate the change of location using optical navigation.

The beam splitter may reflect a linearly polarized light emitted by the laser unit, and penetrates the linearly polarized light which is delayed by half wavelength.

A quarter wave plate may be further disposed on an optical path of light which is reflected from the polarized beam splitter to the ground.

### ADVANTAGEOUS EFFECTS

According to an exemplary embodiment of the present invention, not only two-dimensional geographical information but also data regarding the depth of the pipe are created in a database. Therefore, the pipe is more efficiently maintained and preserved.

An underground pipe is inserted in in the environment in which the water flow is not cut off, and three-dimensional geographical information is acquired. Accordingly, there has no inconvenience of pausing use of the pipe to perform a mapping operation.

If a non-contact odometer using an optical flow sensor is used, a running distance is measured without errors occurring in a situation in which the measured distance varies, or the distance is measured on an uneven surface.

### BRIEF DESCRIPTION OF THE DRAWINGS

FIG. 1 is a view illustrating an apparatus for acquiring three-dimensional geographical information according to an exemplary embodiment of the present invention;

FIG. 2 is a view illustrating the process of acquiring three-dimensional geographical information on an underground pipe using the apparatus of FIG. 1;

FIGS. 3 and 4 are schematic views illustrating a conventional optical odometer;

FIG. 5 is a view illustrating a detecting area of an optical flow sensor when emitting axis of an optical odometer does not correspond to the receiving axis of an optical odometer;

FIG. 6 is a schematic view illustrating an odometer according to an exemplary embodiment of the present invention;

FIG. 7 is a view illustrating ray transmission efficiency of an odometer according to an exemplary embodiment of the present invention; and

FIG. 8 is a view illustrating ray transmission efficiency of an odometer according to another exemplary embodiment of the present invention.

### DESCRIPTION OF THE REFERENCE NUMERALS IN THE DRAWINGS

100: odometer 110, 110′: laser unit
130: optical flow sensor 200, 200′: beam splitter
220: quarter-wave plate 300: in-pipe transferring device
500: underground pipe

### BEST MODE FOR CARRYING OUT THE INVENTION

The components and operations of the present invention will be explained in detail with reference to the drawings.

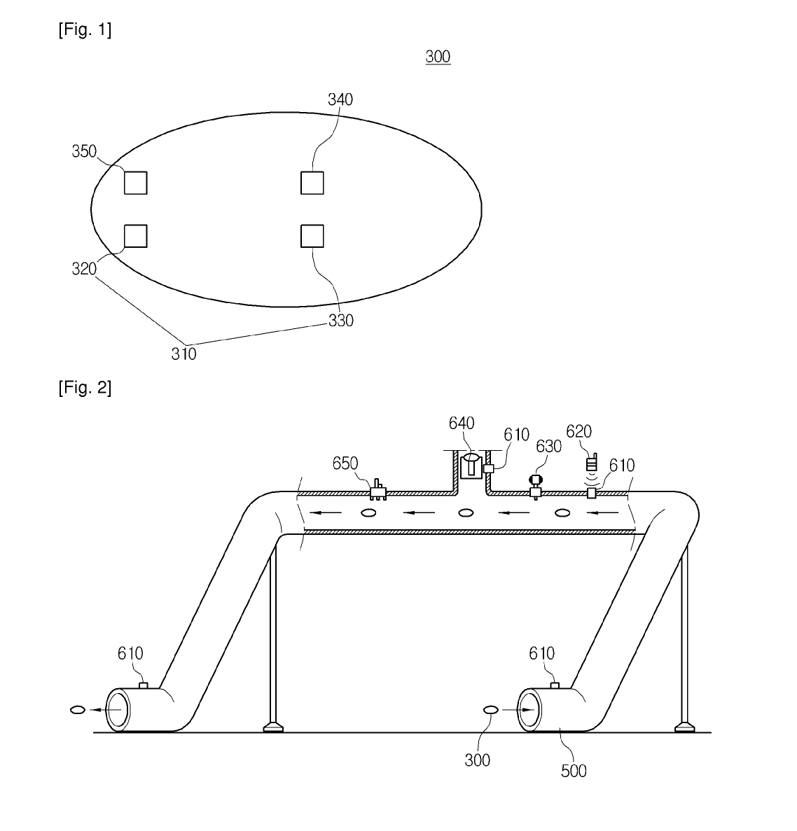

FIG. 1 is a view illustrating an apparatus for acquiring three-dmensional geographical information on an underground pipe according to an exemplary embodiment of the present invention, in which an in-pipe transferring device 300 is shown. The in-pipe transferring device 300 acquires geographical information while the pipe is in a water flow which is not cut off.

The in-pipe transferring device 300 moves in an underground pipe 500, and comprises a detection unit 310 to measure the direction, speed, and distance in which the in-pipe transferring device 300 moves, and a storage unit 340 to store values measured by the detection unit 310.

The in-pipe transferring device 300 may be formed with a diameter smaller than that of the underground pipe 500, and the same specific gravity as fluid flowing in the underground pipe 500, so that the in-pipe transferring device 300 floats on the fluid flowing in the underground pipe 500.

For example, a mapping device moving in a pipe may have a specific gravity of 1. If the in-pipe transferring device is formed as a floating body, additional driving devices, complex machines, or auxiliary devices are not required for fluid to move in the pipe. When the mapping device having a specific gravity of 1 is used in a water pipe, it is possible for the mapping device to acquire geographical information while the water pipe is in constant flow, and to map a considerable distance without requiring a driving mechanism. Accordingly, the mapping device having a specific gravity of 1 has advantage such as a shortened operating time, increased operating area, and reduced inconvenience to a user. The floating body may have a streamlined curved surface in order to minimize fluid resistance, and two or more wings in order to move stably.

The in-pipe transferring device 300 may be formed as a pig body instead of a floating body. The in-pipe transferring device formed as a pig body requires a pig launching device on a pig slot. In this case, the pig body may perform a flushing operation while moving in the pipe. The pig body of the mapping device according to an exemplary embodiment of the present invention may be constructed using other structures disclosed in Korean Patent Application No. 20-2005-0007528 or 20-2003-0039794.

The in-pipe transferring device 300 may be embodied as an in-pipe running robot. The in-pipe running robot may be formed to run along a slope or curved path, and may be, for example, the running robot disclosed in Korean Patent Application Nos. 10-1995-0030874 or 10-2001-0009369. If the in-pipe running robot runs on a slope or curved path, the robot does not have limitations. As the in-pipe running robot includes an encoder to obtain a signal for controlling a wheel driving unit, the encoder signal causes encoder data to be obtained in addition to data obtained from the optical sensor when the running distance and rotation direction of the running robot are calculated Accordingly, the reliability of the geographical information is enhanced.

The detection unit 310 is disposed in the in-pipe transferring device 300, and comprises an active sensor 320 using wireless signals such as radio frequency (RF) signals, and a mapping sensor 330 to measure the direction, speed, and distance in which the in-pipe transferring device 300 moves.

The active sensor 320 may be formed as an active RF sensor to collect information regarding the movement of the in-pipe transferring device 300.

The mapping sensor 330 comprises an accelerometer and a gyroscope. The accelerometer measures the speed of the in-pipe transferring device 300, and the gyroscope measures the direction in which the in-pipe transferring device 300 moves. Thus, the non-contact odometer 100 using an optical flow sensor measures the movement distance of the in-pipe transferring device 300. The non-contact odometer 100 will be explained below.

The in-pipe transferring device 300 may further comprise a wireless communication device 350 to acquire geographical information by communicating with communication modules 610, 620, 630, and 640 (referring to FIG. 2) disposed at predetermined locations in the underground pipe 500, and a camera to acquire inner vision data of the underground pipe 500. The camera acquires inner vision data of the underground pipe 500, and determines the location and condition of the pipe to be repaired, and thus the interior of the pipe can be conveniently and accurately repaired and managed.

The in-pipe transferring device 300 may be waterproof to at least 10 kg/cm² in order to operate in constant flow conditions.

FIG. 2 is a perspective view illustrating a mapping device having a floating body according to an exemplary embodiment of the present invention.

The in-pipe transferring device 300 according to an exemplary embodiment of the present invention is inserted into an air vent disposed in the underground pipe 500. The diameter of the in-pipe transferring device 300 is smaller than that of the underground pipe 500, thereby moving in the pipe according to the direction of flow of the fluid.

The detection unit 310 of the in-pipe transferring device 300 measures the direction and distance in which the in-pipe transferring device 300 moves by measuring the acceleration, angular acceleration, and running distance of the in-pipe transferring device 300 which are used to calculate three-dimensional geographical information, using the active sensor 320, the mapping sensor 330, odometer, or non-contact odometer. The data acquired using the detection unit 310 combine with geographical information regarding an inlet and outlet of the in-pipe transferring device 300, which is acquired using a global positioning system (GPS), and thus the two-dimensional location and depth at which the underground pipe 500 is positioned are measured and mapped using the trace of the in-pipe transferring device 300 and the combined information. If a camera is mounted in the in-pipe transferring device 300, a database may be created by combining vision data in the pipe and geographical information.

As the underground pipe 500 is generally made of metal, electrical waves are unevenly generated. Therefore, the in-pipe transferring device 300 requires the storage unit 340 to store data measured by the detection unit 310.

The wireless communication device 350 is mounted on the in-pipe transferring device 300, and communicates with wireless devices disposed on an intermediate section between the inlet and outlet of the in-pipe transferring device 300 in order to acquire geographical information for compensation. The wireless devices, can be, for example a radio frequency identification (RFID) 610, a communication device 620 connected to a wireless personal area network (WPAN) such as a Zigbee communication module, a pass sensor module 630, a communication module 640 having a fluid crossing valve, or a communication module 650 having an observation monitoring sensor.

The operation of mapping a device comprises operations of loading a measured value stored in the storage unit 340 of the in-pipe transferring device 300, combining geographical information of an inlet, outlet, and intermediate portion of the in-pipe transferring device 300 with geographical information estimated based on the data acquired from a sensor, calculating three-dimensional geographical information of the corresponding portion, and creating a database.

If the three-dimensional pipe network map interacts with a geographic information system (GIS), valve and pipe data applying RFID techniques, in-pipe monitoring image data, or real-time data of an in-pipe monitoring sensor, a system to manage underground pipe may be constructed.

### MODE FOR THE INVENTION

To more accurately map the pipe, it is important to measure the running distance of the in-pipe transferring device 300. The in-pipe transferring device 300 may be formed as a floating body to be used in a water flow which is not cut off. If a contact odometer is used, considerable errors may occur. Thus, it is preferable to a use non-contact odometer.

An odometer using an optical sensor is shown in Table 1 as a representative non-contact odometer.

TABLE

| | | Publishing | Date of | |
|---|---|---|---|---|
| Title | Author | office | issue | Contents |
| Design and | Hyungki | Graduate | 2005.02 | Embodiment of |
| embodiment of optical | KIM | School of | | odometer using three |
| odometer using optical | | Hankuk | | optical odometers |
| mouse | | University of | | |
| | | Foreign | | |
| | | Studies | | |
| Distance sensor data | Seongjin | Graduate | 2006.08 | Embodiment of |
| processing for | PAEK | School of | | odometer using two |
| estimating robot | | Hongik | | optical odometers |
| location | | University | | |
| Estimation of mobile | Byunggeun | Graduate | 2007 | Embodiment of |
| robot location using | MOON | School of | | odometer using an |
| sensor fusion of | | Hankuk | | optical odometer and |
| optical mouse and | | University of | | estimation of mobile |
| encoder | | Foreign | | location using |
| | | Studies | | encoder and sensor |
| | | | | fusion |

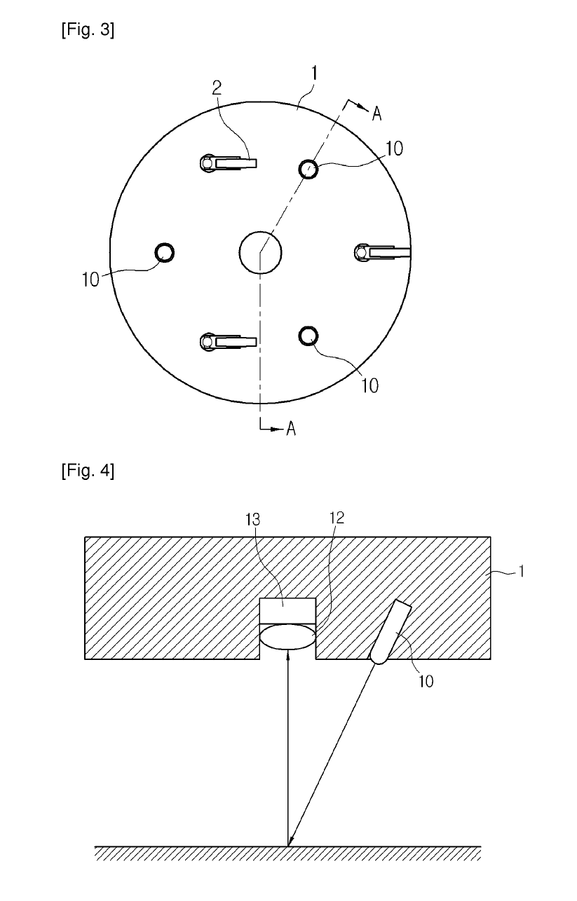

FIG. 3 is a schematic view illustrating a device in which three optical odometers are mounted on the bottom of a movable robot of an optical odometer using an optical mouse, and FIG. 4 is a side sectional view illustrating the apparatus of FIG. 1.

A movable robot body 1 comprises a plurality of wheels 2 in order to move, and three optical odometers 10 on the bottom thereof. The plurality of optical odometers 10 are provided in order to correct errors caused by a wheel drive odometer sliding.

Referring to FIG. 4, an optical flow sensor 13 to converge light emitted from the optical odometer 10 is disposed at the center of the movable robot body 1, and a lens unit 12 to collect the reflected light is provided on the fore surface of the optical flow sensor 13. The optical flow sensor 13 may be simply embodied as an optical flow sensor chip, for example ADNS-6010 of AVAGO TECHNOLOGIES, which is used in optical mice for computers. The optical flow sensor chip such as ADNS-6010 comprises an image acquiring system to receive light, and a digital signal processing system to process the acquired image as a digital signal, and to calculate the direction and distance in which a mobile unit having a sensor unit moves, in order to implement optical navigating techniques. Such techniques are not connected with the main technique, and thus detailed description is omitted.

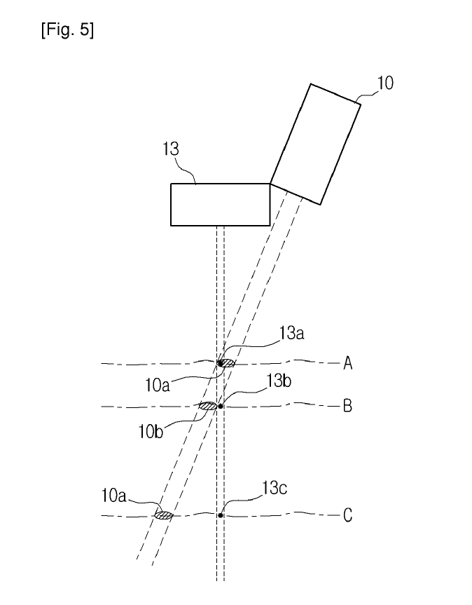

Referring to FIG. 5, if the distance between the odometer and the ground varies between A, B, and C on uneven surface, an emitting axis of the laser beam does not correspond to a receiving axis of the laser beam. On the ground A and B, detecting areas 13a and 13b of the optical sensor 13 detect areas 11a and 11b reflected to the ground, so it is possible to measure the running distance. However, on the ground C, an area 11c reflected by the laser beam does not correspond to an area 13c monitored by the sensor, so the optical flow sensor cannot form an image of the ground. Therefore, if the emitting axis and receiving axis of the laser beam do not correspond with each other, the running distance may be measured between grounds A and B.

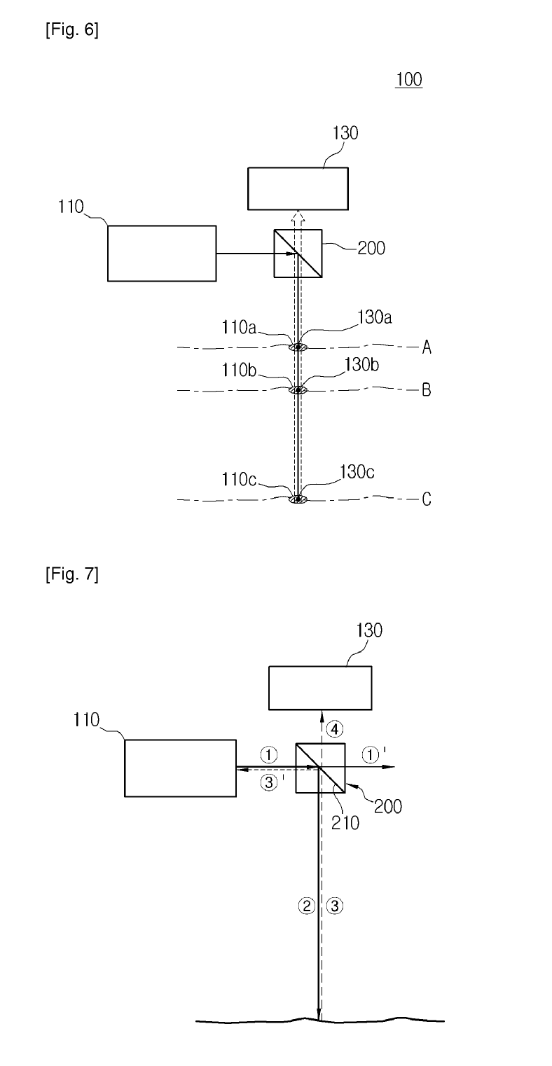

FIG. 6 is a schematic view illustrating a non-contact odometer 100 according to an exemplary embodiment of the present invention.

The non-contact odometer 100 according to an exemplary embodiment of the present invention comprises a laser unit 110, a beam splitter 200, and the optical flow sensor 130.

The laser unit 110 comprises a laser diode and a beam collimator. The laser diode emits a laser beam having a predetermined wavelength, and the beam collimator collimates the laser beam emitted by the laser diode into a parallel laser beam having predetermined investigation areas 110a, 110b, 110c, so that the investigation areas 110a, 110b, 110c of the laser beam are larger than detection areas 130a, 130b, 130c detected by the optical flow sensor 130.

The light receiving surface of the optical flow sensor 130 is disposed apart from the laser unit 110 at a predetermined interval, and is perpendicular to an optical axis of the laser beam emitted by the laser unit 110. The optical flow sensor 130 is connected to a digital signal processing system (not shown) which processes a photoelectrical signal output from the optical flow sensor 130, and calculates the change of location in an optical navigating manner. The optical flow sensor 13 may be embodied as an optical flow sensor chip, for example ADNS-6010 of AVAGO TECHNOLOGIES, which is used in optical mice for computer. The optical flow sensor chip comprises an image acquiring system to receive light, and a digital signal processing system to process the acquired image as a digital signal, and to calculate the direction and distance in which a mobile unit having a sensor unit moves. The construct and operation of the optical flow sensor are well known to those skilled in the art, and thus detailed description is omitted.

The beam splitter 200 is provided on the optical axis of the laser beam emitted by the laser unit 110, reflects the laser beam emitted by the laser unit 110 to the ground surface opposite the light receiving surface of the optical flow sensor 130, and penetrates the light reflected by the ground surface to the light receiving surface of the optical flow sensor 130.

More specifically, reference numerals 110a, 110b, 110c in FIG. 6 represent the illumination areas of the laser beam when the distance between the optical flow sensor 130 and the ground surface varies as indicated by A, B, and C, and reference numerals 130a, 130b, 130c represent the detection area of the optical flow sensor at the time. According to the above construction, the illumination areas 110a, 110b, 110c overlap on the laser beam and the detection areas 130a, 130b, 130c of the optical flow sensor 130 irrespective of the distance between the optical flow sensor 130 and the ground surface, and thus the optical flow sensor 130 can normally detect the laser beam.

FIG. 7 is a view illustrating ray transmission efficiency when a non-polarized beam splitter is used as an odometer according to an exemplary embodiment of the present invention. It is supposed that an optical transferring surface 210 of the beam splitter of FIG. 5 provides 50% reflectiveness and transmittance.

If it is supposed that the intensity of the laser beam \textcircled{1} emitted by the laser unit 110 is 100%, 50% penetrates \textcircled{1}′ to the beam splitter 200, and 50% is reflected, so the intensity of the laser beam \textcircled{2} illuminating the ground surface is 50%. If it is supposed that the reflectiveness of the ground surface is 100%, 50% of the beam \textcircled{3} reflected from the ground surface is reflected \textcircled{3}′ by the beam splitter 200, and thus the intensity of the beam \textcircled{4} emitted to the remaining optical sensor 130 is 25% of the initial laser beam \textcircled{1}. The intensity of the beam entering to the optical flow sensor 130 varies according to the reflectiveness and transmittance (supposed to 50%) of the beam splitter 200 and the reflectiveness (supposed to 100%) of the ground, but the intensity of the initial laser beam emitted from the laser unit 110 may be reduced to 25%.

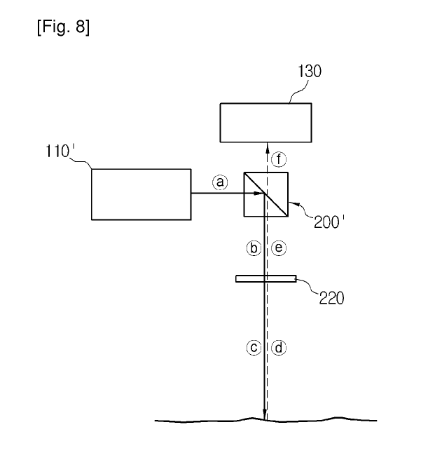

FIG. 8 is a view illustrating improved ray transmission efficiency when a polarized beam splitter 200′ and a quarter-wave plate 220 are used as an odometer according to another exemplary embodiment of the present invention.

It is supposed that a laser unit 110′ emits a P-phase laser beam, and a polarized beam splitter 200′ reflects P-phase 100%, and penetrates S-phase 100%. If it is supposed that the intensity of P-phase laser beam [symbol] output from the laser unit 110 is 100%, the whole of the P-phase laser beam is reflected as indicated by [symbol] to retain the intensity 100%. The beam [symbol] (P+λ/4) penetrating the quarter-wave plate 220 (the transmittance is 100%) is reflected from the ground surface (the reflectiveness is 100%) as indicated by [symbol] . The beam [symbol] reflected by the ground surface penetrates the quarter-wave plate 220, and is changed to S-phase laser beam [symbol] . 100% of the S-phase laser beam [symbol] is penetrated from the polarized beam splitter, and is collimated into the optical flow sensor 130.

The intensity of the beam entering the optical flow sensor 130 varies according to the reflectiveness and transmittance (assumed to be 100%) of the beam splitter 200′ the transmittance (assumed to be 100%) of the quarter-wave plate 220, and the reflectiveness (assumed to be 100%) of the ground, but the intensity of the beam emitted by the laser unit 110′ is maximized to 100%.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

### INDUSTRIAL APPLICABILITY

An exemplary embodiment of the present invention may be used to measure three-dimensional geographical information on an underground pipe, and a non-contact odometer therefore may be used to calculate the running distance of mobile devices such as a car or movable robot.

1. An apparatus for acquiring three-dimensional geographical information on an underground pipe, the apparatus comprising:
an in-pipe transferring device to move in an underground pipe;
a detection means to detect three-dimensional geographical information on the in-pipe transferring device; and
an information storage means to store values measured by the detection means.

2. The apparatus of claim 1, wherein the detection means comprises:
a moving direction measurement unit to measure a direction in which the in-pipe transferring device moves;
a moving speed measurement unit to measure a speed at which the in-pipe transferring device moves; and
a moving distance measurement unit to measure a distance in which the in-pipe transferring device moves.

3. The apparatus of claim 2, wherein the moving direction measurement unit is a gyro sensor, and the moving speed measurement unit is an accelerometer.

4. The apparatus of claim 2, wherein the moving distance measurement unit is an odometer.

5. The apparatus of claim 2, wherein the moving distance measurement unit comprises:
a laser unit to emit a parallel laser beam having predetermined illumination areas;
a sensor unit disposed to be perpendicular to an optical axis of the laser beam emitted by the laser unit; and
a beam splitter disposed on optical axes of the laser unit and the sensor unit, to reflect the laser beam emitted by the laser unit on a ground, and to penetrate the laser beam reflected by the ground to the sensor unit.

6. The apparatus of claim 1, wherein the in-pipe transferring device is formed as a floating body with a diameter smaller than that of the underground pipe so as to float on the fluid flowing in the underground pipe, and having the same specific gravity as the fluid flowing in the underground pipe.

7. The apparatus of claim 1, wherein the in-pipe transferring device is formed as a pig body.

8. The apparatus of claim 1, wherein the in-pipe transferring device is formed as a running robot.

9. The apparatus of claim 1, wherein the detection means further comprises:
a camera device to acquire inner vision data of the underground pipe.

10. The apparatus of claim 1, wherein the detection means further comprises:
a communication module disposed at predetermined locations in the underground pipe; and
a wireless communication apparatus to acquire geographical information by communicating with the communication module.

11. A non-contact odometer, comprising:
a laser unit to emit a parallel laser beam having predetermined illumination areas;
a sensor unit disposed to be perpendicular to an optical axis of the laser beam emitted by the laser unit; and
a beam splitter disposed on optical axes of the laser unit and the sensor unit, to reflect the laser beam emitted by the laser unit on a ground, and to penetrate the laser beam reflected by the ground to the sensor unit.

12. The odometer of claim 1, wherein the sensor unit comprises:
an optical flow sensor comprising a light receiving surface which detects the laser beam; and
a digital signal processing system to process a photoelectrical signal output from the optical flow sensor to a digital signal, and to calculate the change of location using optical navigation.

13. The odometer of claim 12, wherein the beam splitter reflects a linearly polarized light emitted by the laser unit, and penetrates the linearly polarized light which is delayed by half wavelength.

14. The odometer of claim 12, wherein a quarter wave plate is further disposed on an optical path of light which is reflected from the polarized beam splitter to the ground.
